(19) United States
(12) Patent Application Publication
(10) Pub. No.: US 2005/0263234 A1
(43) Pub. Date: Dec. 1, 2005

(54) Reinforced paper product and method for making same

(75) Inventor: Chia Shun Shih, San Antonio, TX (US)

Correspondence Address: Thomas E. Sisson;Jackson Walker, LLP, Suite 2100, 112 E. Pecan, San Antonio, TX, 78205, US

(73) Assignee: Greener Bags, LLC

(21) Appl. No.: 11/196,716

(22) Filed: Aug. 3, 2005

Related U.S. Application Data
(63) Continuation-in-part of application No. PCT/US03/33761, filed on Oct. 28, 2003.

(51) Int. Cl. B29C 31/00; B32B 29/00; B65B 1/00

(52) U.S. Cl. 156/60; 264/257; 428/537.5

(57) ABSTRACT

A composite paper product has inner and outer layers of standard paper bonded to each other and a fiber strand or a densely knitted fiber mat network to form a reinforced paper product. The fiber strand network has a first set of strands extending in a first direction and a second set of strands overlapping the first set and extending in a second direction. In some embodiments the second set of fiber strands overlaps in opposite diagonal directions while overlaying a first set of generally transverse parallel fiber strands. A recyclable binding composition is used to glue the various fiber and paper layers together to yield a unitary sheet of reinforced composite paper.

This continuation-in-part utility application claims priority to U.S. Provisional Application Ser. No. 60/421,497, filed Oct. 28, 2002; and co-pending U.S. Patent application filed Apr. 28, 2005, as a National Phase application of PCT/US03/033761, filed Oct. 28, 2003, which are incorporated herein by reference for all purposes.

### BACKGROUND OF THE INVENTION

Over past centuries paper products have been utilized in various packaging, binding, shipping, storage and building applications in modern life. Currently, most applications incorporate certain common features, namely, single or multi-layered paper sheets are cut, pasted, glued or molded into a desired shape or configuration with various specified dimensions. The tensile strength and abrasive resistance of current paper products is severely limited by the strength of the underlying paper composition. Often the paper strength is inadequate for commercial needs such as shipping, storage, and inter-modal transshipments. Thus, the materials contained or packaged by current paper products will frequently spill out as the result of paper failure, or unexpected breakage or rupture. Such failure causes significant loss of materials and time, workplace contamination and even environmental damage.

The present inventive product and method yields an increased tensile strength and abrasive resistance to the composite product. Depending upon the composition of the reinforcing fiber selected and the fiber configuration or mesh for inclusion in the composite product, the strength and abrasive resistance may be increased hundreds of fold. Further, the composite product may be reused significantly reducing overall paper consumption. With appropriate selection of natural or synthetic fibers, the composite product may be totally recyclable.

### BRIEF DESCRIPTION OF THE DRAWINGS

FIG. 1 is a perspective view of a first embodiment of the composite paper product of the present invention.

FIG. 1A is a detailed view of the fiber strands overlapping.

FIG. 2 is a perspective view of a second embodiment of the composite paper product of the present invention.

FIG. 3 is a perspective view of a third embodiment of the present invention.

FIG. 4A is a top plan view of a first fiber strand arrangement of the present invention.

FIG. 4B is a top plan view of a second fiber strand arrangement of the present 7 invention.

FIG. 5 is a top plan view of an overlapping of first and second fiber strand layers of the present invention.

FIG. 6 is a perspective view of an embodiment of the present invention illustrating an insulation composition covering a layer of paper of the present invention.

FIG. 7 illustrates an abrasive resistant covering of the present invention with a gypsum layer sandwiched therebetween.

FIG. 8 is a flow diagram of the process of the present invention.

FIG. 9 illustrates an embodiment of the present invention wherein a paper layer is bonded with a densely knitted fiber mat.

FIG. 10 is an exploded perspective view of yet another embodiment of the present invention wherein the densely knitted fiber mat (shown in strips) is bonded between two separate layers of recyclable paper or board.

FIG. 11 shows a multi-layer combination of paper and knitted mat layers bonded together.

FIG. 12 illustrates yet another embodiment of reinforced paper board for insulation or construction utilizing the densely knitted fiber mats with board or paper and an additional application layer of particle wood, plastic board, or insulation material.

### DETAILED DESCRIPTION OF THE PREFERRED EMBODIMENT

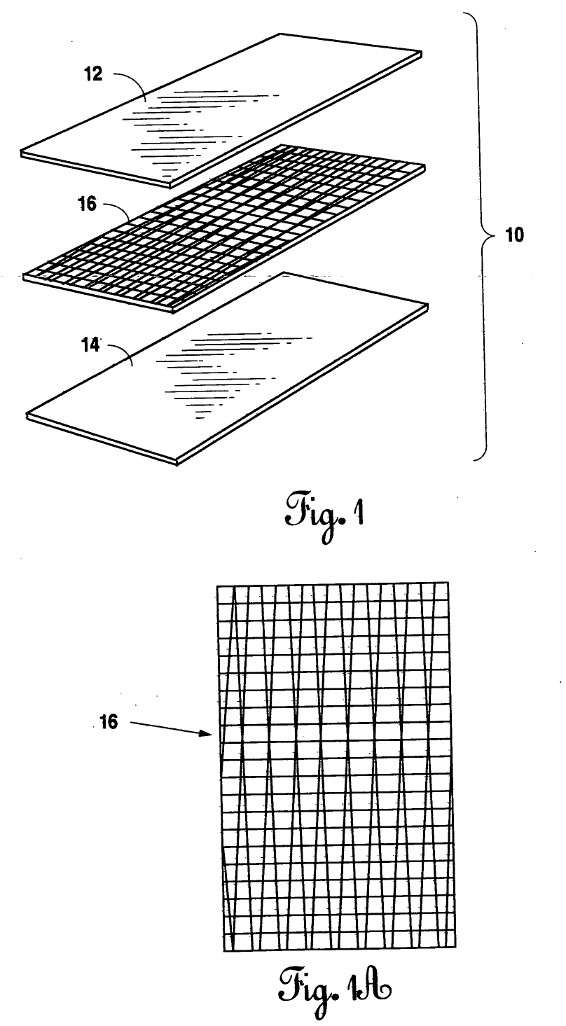

The reinforced composite paper product of the present invention presents a unique reinforcement of woven natural and synthetic fiber nets glued or bonded between two or more layers of natural, standard paper sheets. FIG. 1 illustrates the simple configuration of the present inventive composite product 10.

A first paper layer 12 and a second paper layer 14 have a bonded fiber strand network 16 therebetween. FIG. 1A illustrates a detailed view of a pattern of the fiber strand network 16. The fiber network 16 is made up of at least two sets of overlapping fiber strands (each strand is comprised of a multiplicity of individual fiber filaments) which are woven and folded between the paper layers 12 and 14 as described below. The fiber strand network 16 may be made of the following man-made or natural fibers including but not limited to: polyester staple, polyester conjugate, acrylic, viscose staple, glass, nylon, polypropylene, acetate, aramid, asbestos, charvet, elastomerr, glass fibers, latex, manufactured fiber, metallic fibers, modacrylic nylon, olefin fiber, PBI, polyester, protein base fibers, rayon, Spandex® Sulfar®, Vivyon®, polyamide fibers, vinyl, wool and related mammalian fibers, silk, jute and kenaf, other long vegetable fibers, abaca, banana, sisal, henequen, flax, ramie, hemp, sunn, and coir, cotton, cellulose acetate and triacetate fibers.

As would be understood by one of ordinary skill in the art, the reinforced composite product 10 may be used for boxes, bags, molded containers, thermal insulation, waterproofing, corrosion resistant fire retardant building or packaging materials, etc. Application of the present inventive fiber reinforced paper product may result in the following features: waterproofing, tensile strength reinforcement, thermostability, aging retardation, high anti-abrasion capability, and minimize breakage or ruptured rate. With selection of an appropriate fiber-net material and a gluing compound such as the Vinylon® soluble yarn without condensating aldehydes-treatment, and a PVA based glue, the composite paper product may be easily dissolved in warm water and become totally recyclable without pollution to the environment. The paper composite product of the present invention may be applied to packaging or bagging of all kinds, powdered and particulate materials for agriculture grains, animal feed, cheese, starch and the floury food products, cement, fertilizers, pesticides, herbicides, talcum powder, titanium white, carbon black, calcium carbide, asphalt, and all kinds of chemical and mineral products.

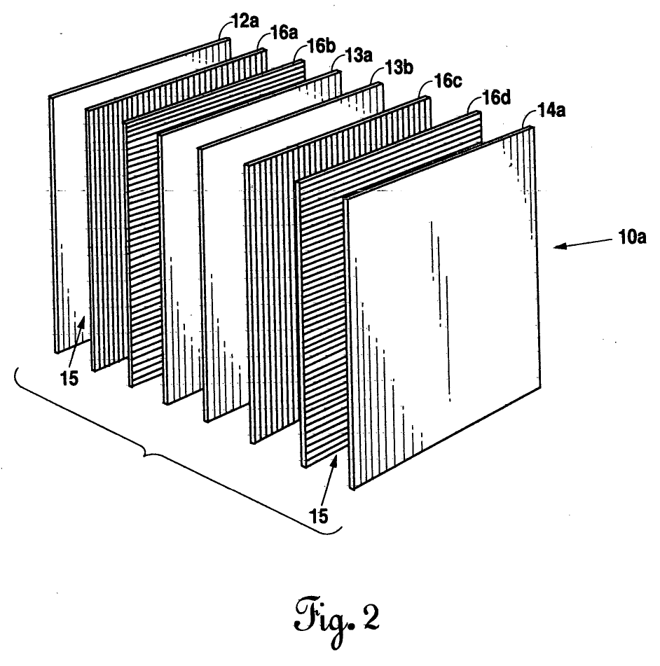

FIG. 2 illustrates an exploded perspective view of an embodiment of the present invention 10a wherein multiple layers of paper 12a, 13a, 13b, and 14a are separated by multiple layers of fiber strand sets 16a, 16b, 16c, and 16d. FIG. 2 illustrates the strand sets 16a, 16b, 16c, and 16d as if they are woven sheets for simplicity purposes. However as will be understood below that the warp and woof (or weft) of the strands are laid down in a weaving process. It is believed that fiber strand network 16 may be woven as separate sheets or nets and placed and glued or bonded between the paper layers and the layers.

It should be noted in FIG. 2 that a plurality of first fiber strands 16a and 16c extend in a first linear direction and each separate first fiber strand (made up of multifiber filaments) is generally parallel to the next separate strand. This is a first direction or orientation for the first fiber strands 16a. A second plurality of fiber strands 16b and 16d extend in a second diagonal direction and each second fiber strand is generally parallel to the next strand. As shall be noted below, a third diagonal direction may be used on a portion of the second strands 16a and 16d which is opposite the second diagonal direction.

In the embodiment of FIG. 2, it will be seen that two paper sheets or layers 13a and 13b may be glued adjacent one another without detracting from the advantages of the present invention. Either or both of the outermost sheets of paper 12a and 14a may be coated, covered, or treated with a variety of compositions to integrate special characteristics to the composite product. These compositions may include a water proofing treatment composition, a corrosion proofing or resistance treatment composition, a thermal insulation composition, a fire retardation composition, and an abrasion resistance composition.

A binding composition or glue 15 is disposed or deposited between the paper layers and retains the first fiber strands 16a and 16b and the second fiber strands 16c and 16d in the directions noted above. The glue 15 also binds or adheres the paper layers together to create a unitary, composite, reinforced fiber paper product or sheet. As noted below, the glue may be applied first to the warp yarn.

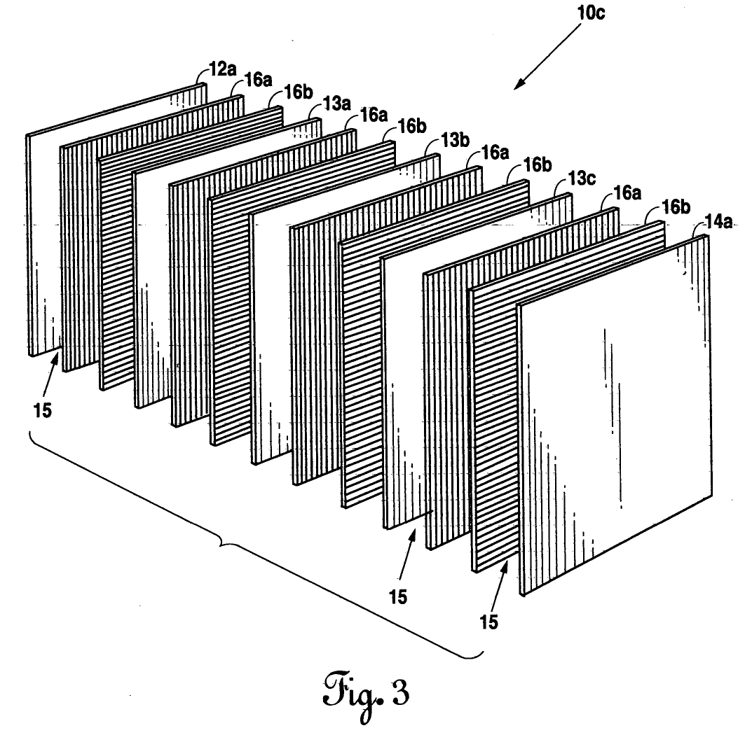

FIG. 3 illustrates another embodiment 10c of the present invention wherein a plurality of paper sheets 12a, 13a, 13b, 13c, and 14a are separated by a plurality of first fiber strand sets 16a extending in a first direction and a plurality of second fiber strand sets 16b extending in a second diagonal direction between two adjacent layers of paper. As noted above, a binding composition such as polyvinyl alcohol (PVA) or other biodegradable glue 15 is used to hold the layers of paper and fiber together in a unitary sheet. The fibers themselves may be made of PVA.

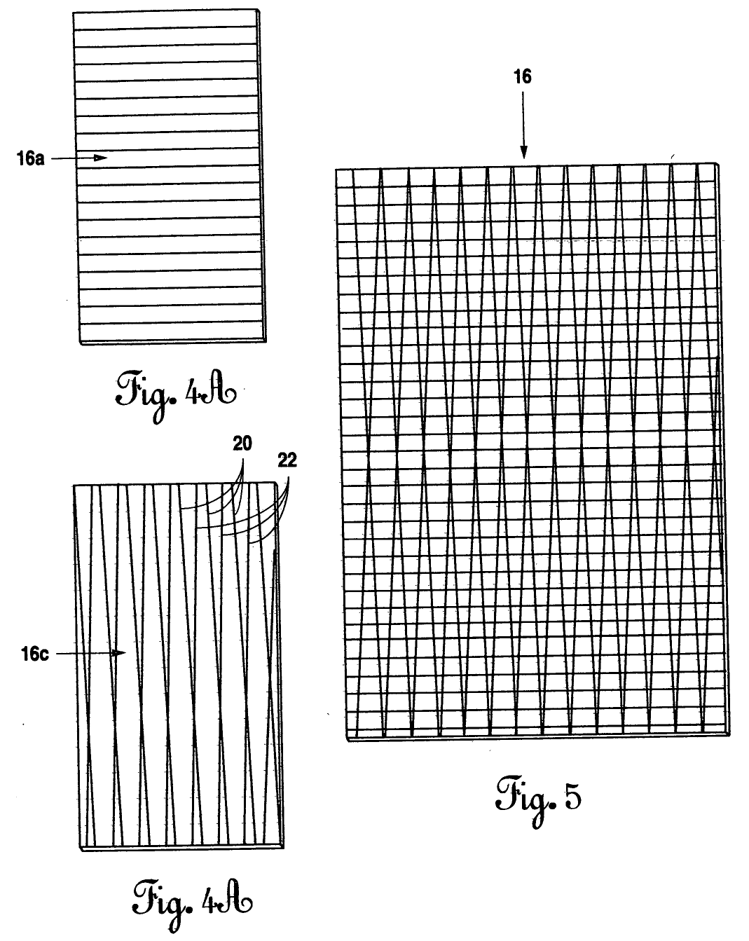

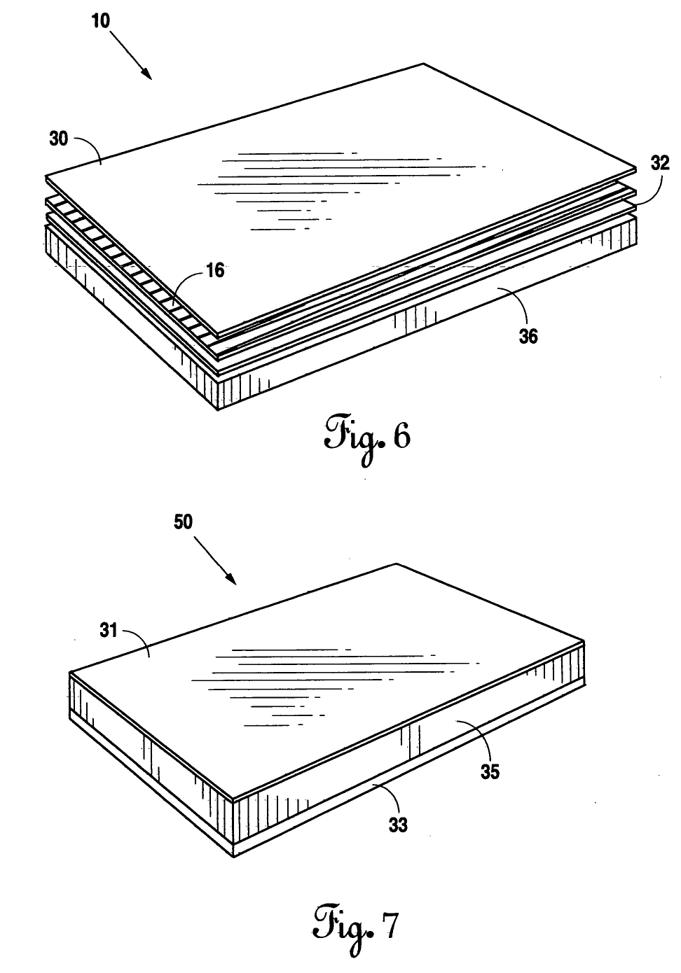

In FIGS. 4A, 4B, and 5, the fiber strand network 16 is shown in greater detail. FIG. 4A illustrates the first fiber strand pattern 16a which is made up of generally transverse, parallel rows of fiber filament bundles. FIG. 4B shows a second fiber strand pattern 16c with a first portion of the strands 20 extending diagonally in a generally parallel configuration in one direction and a second portion of fiber strands 22 extending diagonally in a generally parallel configuration in an opposite direction. FIG. 5 illustrates how the two patterns 16a and 16c have been overlain to form the network 16.

FIGS. 6 and 7 are illustrative of how the composite product of the present invention may be combined with insulation material 36 (FIG. 6) or even composite gypsum board 50 (FIG. 7) to form very functional building materials. In FIG. 6, an exterior paper layer 30 has been bonded to a fiber strand network 16 and an interior paper layer 32. This forms a very strong construction paper product to which an insulation material 36 has been bonded.

FIG. 7 illustrates a different building product 50 which incorporates two sheets of the composite reinforced paper product 31 and 33 with a section of gypsum material 35 sandwiched therebetween. This product 50 has a very high abrasion resistance and may be used in numerous building applications.

As should be understood, the composite paper product of the present invention may be used to make bags, boxes, containers, tarps, cups and many other paper products which may be enhanced by its reinforced strength and recyclable attributes.

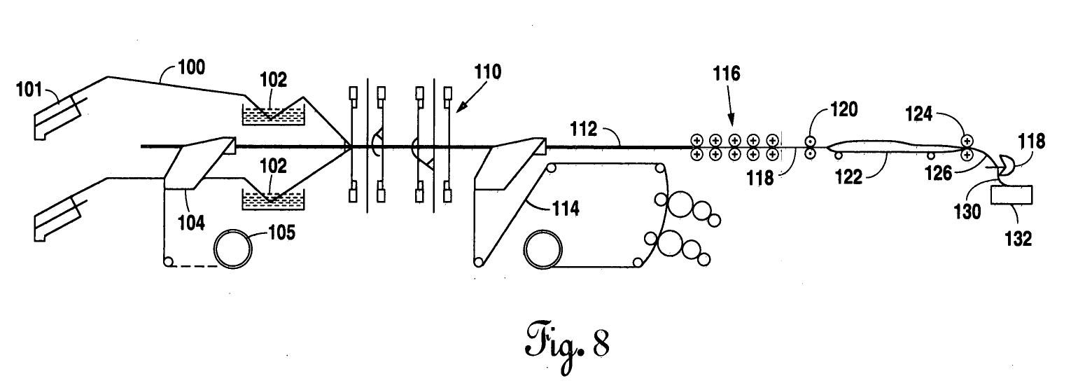

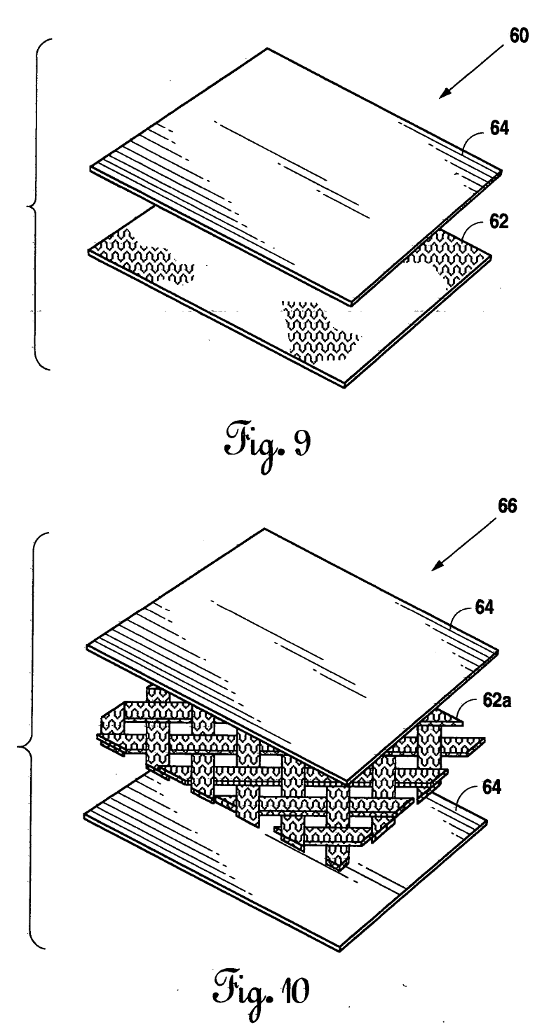

A preferred process for constructing or manufacturing the present inventive paper product is illustrated in FIG. 8 and is described as follows:

1. The multiple lines of warp yarn 100 are rolled off the spindles 101.

2. All lines of the warp yarn are dipped through the glue bath 102.

3. At the same time when the warp yarn 100 begins its movements, pre-sized interior layer of paper 104 is rolled off the paper spool 105 and is pulled under the warp yarn 100. A portion of the glue is disposed on the paper layer 104.

4. Preset lines of weft (or woof) yarn 110 are pulled to form a transverse net and passed above the warp yarn and the interior paper.

5. The net 16 formed by the yarn and the interior paper are moved by rollers and warped into a paper tube 112.

6. The printed exterior paper 114 is pulled to wrap around the tube and moved through the calendar 116 to press into a tube made of composite paper 118 with the fiber net reinforcement.

7. The tube is rolled through a pinhole-punching machine 120.

8. The punched paper tube 122 is then rolled through the margin-folding machine 124.

9. The folded paper tube 126 is then moved through the bag-cutting machine 128 based on preset length.

10. The bag 130 is then dropped into a bag bin 132 for further processing.

In case a flat composite paper sheet is the final product, the paper tube made through step number 6 will be diverted to a horizontal cutting machine which can cut the tube into flat sheet.

It should be understood in the current process of FIG. 8 that with the selection of the yarns made of polyvinyl alcohol (PVA), the composite paper products are totally recyclable. Normally, PVA is frequently applied in paper making and can be dissolved easily and the temperature above 200° F. Multiple layers of paper with the fiber net glued between the paper can easily be produced with the sequential application of the present inventive production process.

Generally, the invented composite paper with the fiber net and the PVA glue is water resistant in normal conditions. In view of the strength requirements and preferences of fiber nets made of natural or synthetic material, different fiber nets can be applied.

While a fiber network 16 made of at least two overlaying strands has been described above in composite products 10a, 10b, and 10c, it has been found that replacing the strands with a densely knitted fiber mat yields many of the positive results of the embodiments in FIGS. 1-7.

In FIG. 9, the most simple reinforced paper product 60 may be made by affixing a single densely knitted mat or sheet 62 made of the man-made or natural fibers of the types discussed above with the other embodiments with a biodegradable or recyclable paper layer 64. Again, the appropriate selection of a densely knitted fiber mat material and a gluing compound, such as Vinylon® soluble yarn without condensating aldehydes-treatment, and a PVA based glue, the composite paper product 60 may be easily dissolved in warm water and become totally recyclable.

The pile or knit density of the mat or sheet may be varied according to the application or use. Alternatively, strips of knitted material may be used to form a network rather than a single continuous mat or sheet. In such a strip embodiment, the strips may be overlapped as the strands were overlapped in the embodiments of FIGS. 1-5 discussed above.

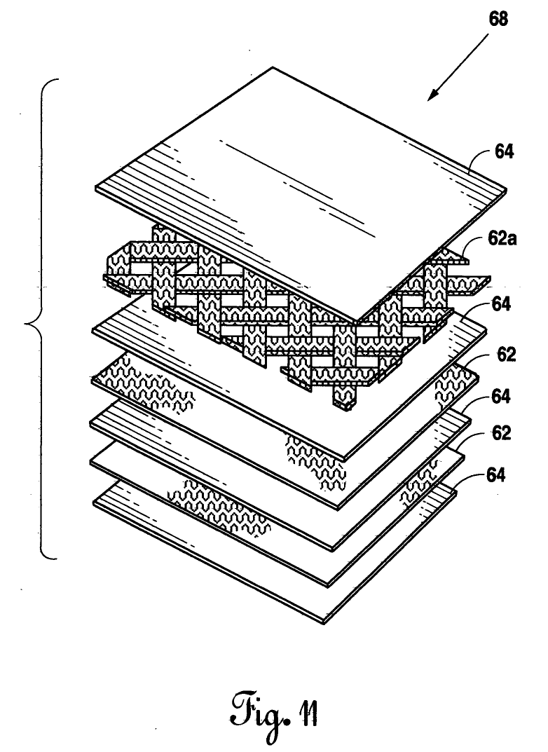

FIG. 10 illustrates two layers of paper/board layer and one layer of a densely knitted mat. The reinforced composite product 66 is similar to the product 10 of FIG. 1, but the overlapping fiber strands are replaced by a network of densely knitted strips to form mat or sheet 62a. Again, the layers are bonded together with a glue or adhesive between each paper layer 64 and the network mat 62a. The strips of knitted matting shown being utilized on layer 62a reduce material and construction costs and allow for a variation in strength of the product 66.

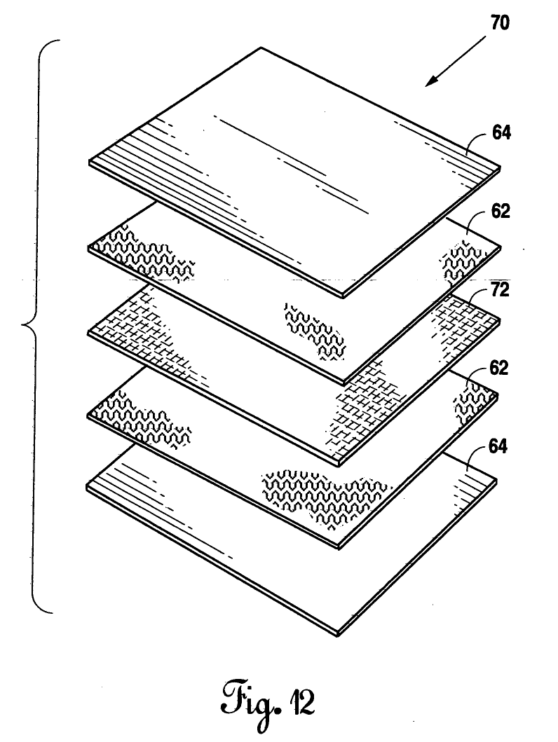

As with the product 10a in FIG. 2 and the product 10c in FIG. 3, a multiple layer composite product 68 with the knitted mat layers 62 and 62a bonded to alternating paper layer 64 may be provided as shown in FIG. 11. As with other embodiments of the composite product, varying layers of knitted strips may be used and overlapped as previously discussed.

A special type of reinforced paper/board composite product 70 is illustrated in FIG. 12. Upper and lower layers of paper 64 are bonded to adjacent densely knitted single, continuous mat layers 62. An application appropriate layer 72 of particle wood, plastic board, or insulation is then bonded to the two adjacent knitted mat layers. This special type of composite may be used in construction applications where a light, rigid board is useful or in an application where thermal insulation would be appropriate. Again, a network of knitted strips may be used to replace single, continuous layers to adjust for strength and flexibility requirements.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A reinforced composite paper product comprising:
at a first paper layer and at least a second paper layer;
a plurality of first fiber strands extending across said first paper layer in a first direction;
a plurality of second fiber strands extending across said first fiber strands in a second direction;
a binding composition disposed between said first paper layer and said second paper layer, said composition retaining said first fiber strands and said second fiber strands in said directions and binding said strands between said first and said second paper layers and further binding said first paper layer to said second paper layer.

2. A reinforced composite paper product comprising:
a plurality of paper layers;
a plurality of first fiber strands extending in a first direction between any two adjacent layers of said plurality of paper layers;
a plurality of second fiber strands extending in a second direction between said any two adjacent layers of said plurality of paper layers;
a binding composition disposed between said any two adjacent layers of said plurality of paper layers, said composition retaining said plurality of said first and second fiber strands in said directions and binding said strands between said any two adjacent paper layers and further binding said any two adjacent paper layers to each other.

3. The composite paper product of claim 2 wherein said binding composition is disposed between said plurality of paper layers binding all of said paper layers and said fiber strands into a single, multi-layered composite sheet.

4. The composite paper product of claim 3 wherein said all of said first fiber strands extend in a same first direction and all of said second fiber strands extend in a same second direction.

5. The composite paper product of claim 1 wherein a portion of said plurality of second fiber strands extend across said fist fiber strands in a third direction.

6. The composite paper product of claim 5 wherein a first portion of said second fiber strands extends diagonally across said first fiber strands in a first diagonal direction and a second portion of said second fiber strands extends diagonally across said first fiber strands in a second opposite diagonal direction.

7. The composite paper product of claim 1 wherein an outermost first and second paper layer is covered with a composition selected from the group consisting of a water proofing treatment composition, a corrosion proofing treatment composition, a thermal insulating composition, a fire retardation composition, and an abrasion resistance composition.

8. The composite paper product of claim 2 wherein an outermost one of said plurality of paper layers is covered with a composition selected from the group consisting of a water proofing treatment composition, a corrosion proofing treatment composition, a thermal insulating composition, a fire retardation composition, and an abrasion resistance composition.

9. A method of producing a reinforced composite paper product comprising:
a. rolling multiple lines of a warp yarn fiber from a multiplicity of warp spindles;
b. passing said warp yarn fibers through a glue bath;
c. rolling an interior layer of paper beneath said glue bathed warp yarn fibers;
d. transversely weaving weft yarns over said glue bathed warp yarn fibers and said interior layer of paper to form a fiber strand network;
e. rolling said network in said interior paper layer via rollers to form a reinforced paper tube;
f. wraping around said reinforced paper tube an exterior layer of paper;
g. passing said reinforced paper tube and said exterior layer of paper through a calendar to press said tube and exterior layer into said reinforced, composite paper product.

10. The reinforced composite paper product of claim 1 wherein said first and said second plurality of fiber strands are densely knitted fiber mat strips.

11. The reinforced composite paper product of claim 2 wherein said first and said second plurality of fiber strands are densely knitted fiber mat strips.
